(19) United States
(12) Patent Application Publication
(10) Pub. No.: US 2020/0247479 A1
(43) Pub. Date: Aug. 6, 2020

(54) VEHICLE CHASSIS AND USE THEREOF

(71) Applicants: ThyssenKrupp Steel Europe AG, Duisburg (DE); thyssenkrupp AG, Essen (DE)

(72) Inventor: David Pieronek, Dortmund (DE)

(73) Assignees: ThyssenKrupp Steel Europe AG, Duisburg (DE); thyssenkrupp AG, Essen (DE)

(21) Appl. No.: 16/480,471

(22) PCT Filed: Jan. 16, 2018
(86) PCT No.: PCT/EP2018/051011

§ 371 Date: Sep. 26, 2019

(30) Foreign Application Priority Data
Jan. 24, 2017 (DE) 10 2017 201 068.1

(51) Int. Cl. B62D 29/00; B62D 21/03; B62D 27/02; B62D 27/06; C22C 38/50; C22C 38/48; C22C 38/06; C22C 38/04; C22C 38/02; C22C 38/00

(52) U.S. Cl. CPC B62D 29/007; B62D 21/03; B62D 27/023; B62D 27/065; C22C 38/50; B60K 1/00; C22C 38/06; C22C 38/04; C22C 38/02; C22C 38/002; C22C 38/001; C22C 38/48

(57) ABSTRACT

The invention relates to a vehicle frame for receiving at least one vehicle component, comprising two substantially parallel longitudinal members, which extend at a distance from one another over their entire extent and are connected together by means of at least two transverse members joined by material bonding, non-positive engagement and/or positive engagement, at least one of the longitudinal members and/or at least one of the transverse members consisting of a reduced-density steel alloy.

### FIELD

The invention relates to a vehicle frame for receiving at least one vehicle component, comprising two substantially parallel longitudinal members, which extend at a distance from one another over their entire extent and are connected together by means of at least two transverse members joined by material bonding, non-positive engagement and/or positive engagement. The invention also relates to a use of the vehicle frame.

### BACKGROUND

Today there is great pressure to make vehicles, in particular motor vehicles, of a lightweight construction, in order to meet the continually increasing requirements for fuel consumption, CO2 emissions, and also high bearing loads, in particular in the case of commercial vehicles, with at the same time a scarcity of available resources and general commercial conditions to be satisfied.

Corresponding advances in the lightweight construction of vehicle structures have been made in recent years, mostly as a result of optimized structural designs and the use of further-developed materials, such as for example hot-forming steels, materials of light metal or fiber-reinforced plastics. In particular when using alternative materials to steel, greater production expenditures and increasing production costs are generally incurred, and they are therefore not suitable or feasible for every application.

In the production of vehicle supporting structures, for example vehicle frames, in particular ladder-type frames for semitrailers, conventional steel profiles are used for assembly. The steel alloys that are used for vehicle frames must have sufficient strength and fatigue resistance under vibrational loading, in particular with at the same time sufficient deformability. These requirements are met by using conventional structural steel alloys (S355), which are shaped into their final geometry by cold forming. The prior art, in particular patent specification EP 2 808 232 B1, discloses inter alia using steel alloys with strengths of between 350 and 700 MPa, which are first shaped into profiles and then assembled to form a vehicle frame.

An increase in component performance can be achieved for example by using multiphase steels, such as for example dual-phase, complex-phase or heat-treatable steels. As alternatives or together, these steels offer a certain potential for lightweight construction, they can have high strengths in the final state and can be used in areas in which existing material concepts, with for example low strength, can be substituted. As a result of the higher strengths, substitution allows material thicknesses to be reduced in component design, with the performance remaining substantially the same, which consequently has advantageous effects on reducing the mass used. Studies have shown that, under vibrational loading, steel materials with very high strengths have great sensitivity with respect to weak points, at least in certain regions, such as for example joints, edges or notches, and consequently it is generally the case that the existing potential for lightweight construction may be negated.

Against the background of the known prior art, steels of higher strength can only be used to a restricted extent as a material for vehicle frames. In particular, a reduction in sheet thickness in comparison with the materials that are conventionally used can only be conducive to success if the loss of stiffness in the case of components for which bending is dominant falls disproportionately.

With respect to the prior art, there is further potential for improvement of vehicle frames, in particular with regard to the use of conventional production lines, with at the same time high structural durability and safety of the vehicle frames produced, in particular with lowest possible weight.

### SUMMARY OF THE INVENTION

The invention was consequently based on the object of providing a vehicle frame which can be made as easily as possible on existing production lines and can ensure high structural durability and safety of the (lightweight) vehicle frame produced, and also the object of specifying a corresponding use of the (lightweight) vehicle frame produced.

According to a first aspect of the invention, the object is achieved with respect to the vehicle frame according to the invention by at least one of the longitudinal members and/or at least one of the transverse members consisting of a reduced-density steel alloy.

The inventor has found that, by the use of a reduced-density steel alloy for the longitudinal member(s) and/or for the transverse member(s), the vehicle frame according to the invention can have a reduced mass in comparison with the material that is conventionally used. If, with particular preference, the reduced-density steel alloy is used in the longitudinal member, preferably in both longitudinal members, the predominant part of the vehicle frame has a substantially lower density, and thereby a lower mass. Consequently, with a performance that is substantially comparable or stays the same, lower masses can be used in the longitudinal member and/or in the transverse member, which can have advantageous effects on a reduction of the mass used.

Providing reduced-density steel alloys allows conventional production lines to continue being used and thereby individual components for the vehicle frame to be produced at low cost, since the reduced-density steel alloys, in particular in their as-supplied state or cold processing state, have moderate strengths, which are comparable to those of steel alloys previously conventionally used, and as a result have suitable forming properties, which are particularly suitable for the shaping of the longitudinal member and/or the transverse member.

The longitudinal members are for example shaped into open profiles with a substantially C-shaped or S-shaped cross section, being assembled with the transverse members to form a kind of ladder-type frame. Alternatively, the longitudinal members may for example be shaped into closed profiles, then being assembled with the transverse members to form a kind of box-type frame. The cross section or the configuration of the transverse members depends on the application, it being possible for the transverse member to be formed as an open or closed profile, in particular also in a multipart configuration. Furthermore, the longitudinal member may for example also be configured as a T- or I-profile, in particular in the case of the I-profile the web, and possibly also the flanges, consisting of a reduced-density steel alloy.

According to a first configuration of the vehicle frame according to the invention, the reduced-density steel alloy has a density of a maximum of 7.4 g/cm³, in particular a maximum of 7.2 g/cm³, with preference a maximum of 7.0 g/cm³. The lower the density, the more advantageous an effect this has on a weight reduction of the vehicle frame according to the invention. The density is for example restricted to a minimum of 5.5 g/cm³.

According to a further configuration of the vehicle frame according to the invention, the reduced-density steel alloy contains the following alloying constituents in % by weight:

### C: up to 0.4%,

### Al: 3.0-20.0%,

### P: up to 0.1%,

### S: up to 0.1%,

### N: up to 0.1%,

and optionally one or more of the elements

### Nb: up to 0.5%,

### Ti: up to 0.5%,

at least one assigned element from the group of rare earth metals: up to 0.2%,

### Mn: up to 20.0%,

### Si: up to 2.0%,

### Cr: up to 9.0%,

### Zr: up to 1.0%,

### V: up to 1.0%,

### W: up to 1.0%,

### Mo: up to 1.0%,

### Co: up to 1.0%,

### Ni: up to 2.0%,

### B: up to 0.1%,

### Cu: up to 3.0%,

### Ca: up to 0.%,

the remainder Fe and unavoidable impurities.

The desired properties in the reduced-density steel alloy are set by means of the alloying elements. Aluminum is an element with a density of about 2.7 g/cm³ and expands the crystal lattice of steel. To be able to achieve a significant density reduction in the steel alloy, the minimum content is at least 3.0% by weight, in particular at least 5.0% by weight, preferably at least 6.0% by weight. Contents above 20.0% lead to the formation of undesired, brittle intermetallic phases, the contents being restricted in particular to a maximum of 15% by weight, preferably to a maximum of 12% by weight, to allow the effect of aluminum to be used particularly effectively.

Carbon may be present with a content of up to 0.4% by weight. To be able to ensure sufficient suitability for joining, the carbon content may in particular be restricted to a maximum of 0.3% by weight. Preferably, the carbon content may be restricted to a maximum of 0.1% by weight, in order to avoid precipitates in the form of undesired, brittle carbides, and consequently to substantially reduce a disadvantageous impairment of the suitability for forming.

Phosphate may be present with a content of up to 0.1% by weight. To substantially reduce segregations, which can have an adverse effect on the mechanical properties, in the steel, the content may be restricted to a maximum of 0.01% by weight.

Nitrogen and sulfur adversely influence the properties of the steel alloy, in particular by formation of sulfides and nitrides, and are therefore restricted to contents of a maximum of 0.1% by weight. In particular, the contents of sulfur may be restricted to a maximum of 0.01% and nitrogen to a maximum of 0.02%, whereby the suitability for vibrational loading of the steel alloy is not substantially adversely influenced.

Niobium and/or titanium fix carbon in particular, and may be respectively restricted to a content of up to 0.5% by weight, in particular up to 0.3% by weight, in order substantially to avoid undesired, great precipitates in the steel alloy. Minimum contents of in each case at least 0.01% by weight can positively influence the control of the microstructure in the steel alloy.

At least one assigned element from the group of rare earth metals (cerium and/or lanthanum) may be present with a content of up to 0.2% by weight, in order substantially to avoid undesired, great precipitates in the steel alloy. To be able to have a positive influence on the control of the microstructure in the steel alloy, the content of the at least one assigned element from the group of rare earth metals may be at least 0.01% by weight.

Manganese, in each case with a content of at least 0.01% by weight, has in particular a positive influence on the strength in reduced-density steels. At high contents, it leads to the formation of hardening structures (α′ and ϵ martensite) and to TRIP- or TWIP-capable austenite and to particularly good strength-ductility relations. Above 20.0% by weight, there is a reduction in these mechanisms of induced plasticity, and no point in any further alloying with relevant costs. Manganese can in particular be added up to a maximum of 10.0% by weight, in particular up to a maximum of 3.0% by weight.

Silicon and/or chromium, in each case with a content of at least 0.01% by weight, may in particular have a positive influence, in particular on the corrosion resistance. Silicon with a content above 2.0% by weight leads to the formation of undesired, brittle intermetallic phases. Chromium, with a maximum of up to 9.0% by weight, in particular in combination with aluminum, leads to good corrosion resistance, while there is no point in any further alloying with relevant costs. In particular, the contents may be respectively restricted to a maximum of 1.0% by weight, preferably respectively to a maximum of 0.5% by weight.

Zirconium, vanadium, tungsten, molybdenum and/or cobalt are carbide-forming elements and may be present in each case with a content of up to 1.0%. Their content may be respectively restricted to a maximum of 0.5% by weight.

Nickel and/or copper may be present in each case with a content of up to 2.0% by weight and, in each case with at least a content of 0.01% by weight, can improve the corrosion resistance. In particular, the content may be respectively restricted to a maximum of 0.5% by weight.

Boron can be conducive to the formation of a fine microstructure and may be present with a content of up to 0.1% by weight, it being possible for the content to be restricted to a maximum of 0.01% by weight to be able to use the effect of boron effectively.

Calcium may serve for the fixation of sulfur and may be present with a content of up to 0.1% by weight. In particular, the content may be restricted to a maximum of 0.01% by weight.

According to a further configuration of the vehicle frame according to the invention, the transverse members are joined to the longitudinal members by material bonding, in particular by means of welding, preferably by means of MIG, MAG, laser welding or brazing. For example, friction stir welding or resistance spot welding are also conceivable. Alternatively, a non-positive connection, in particular a mechanical connection, such as for example a riveted or screwed connection, is also conceivable.

According to a further configuration of the vehicle frame according to the invention, the longitudinal member and/or the transverse member are in each case shaped by means of compression forming, tensile forming, tensile/compression forming, bending, shear forming or deep drawing, in particular by means of hot forming with at least partial press hardening, or by means of a combination of the stated production processes. Depending on the application and design, in particular of the longitudinal members, edging or roll profiling are used with preference.

The second aspect of the invention relates to the use of the vehicle frame according to the invention in automobiles, commercial vehicles, trucks, special vehicles, buses, coaches, whether with an internal combustion engine and/or electrical powertrain, trailers or the like.

### BRIEF DESCRIPTION OF THE DRAWINGS

The invention is explained in more detail below on the basis of a drawing showing exemplary embodiments. The same parts are always provided with the same designations. In the figures:

FIG. 1) shows a first configuration of a vehicle frame according to the invention in a perspective representation and

FIG. 2) shows a second configuration of a vehicle frame according to the invention in a perspective representation.

### DETAILED DESCRIPTION

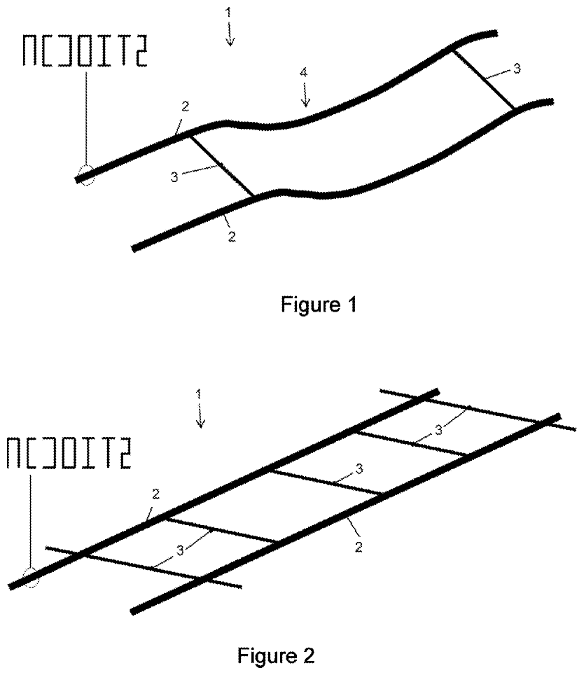

In FIG. 1), a perspective representation of a first configuration of a vehicle frame (1) according to the invention is schematically shown, in particular for an automobile, for example for an off-road vehicle. The vehicle frame in FIG. 1) comprises two substantially parallel longitudinal members (2), which extend at a distance from one another over their entire extent and are connected together by means of at least two transverse members (3) joined by mechanical joining techniques, for example riveting. The transverse members (3) are for example formed from a rolled profile with a closed cross section. The longitudinal members (2) are formed as a closed profile and have in their middle an offset region (4). Furthermore, additional reinforcing and/or stiffening elements, which are not shown here, may be arranged, as well as means, in particular connecting brackets, for receiving vehicle components (likewise not shown here), such as for example the engine, transmission, axles and the vehicle body. The construction is configured as a box-type frame. In the small representation in FIG. 1), possible configurations for designing the cross section for the longitudinal members (2) are shown by way of example.

In FIG. 2), second configuration of a vehicle frame (1) according to the invention is schematically shown in a perspective representation, in particular for a trailer, for example for a semitrailer. The vehicle frame in FIG. 2) comprises two substantially parallel longitudinal members (2), which extend at a distance from one another over their entire extent and are connected together by means of five transverse members (3) joined by material bonding, preferably by means of MIG or MAG welding. The transverse members (3) are formed for example as edge profiles with an open cross section. The longitudinal members (2) are formed as a C profile. Furthermore, additional reinforcing and/or stiffening elements, which are not shown here, may be arranged, as well as means, in particular connecting brackets, for receiving vehicle components (likewise not shown here), such as for example axles and the vehicle body. The construction is configured as a ladder-type frame. In the small representation in FIG. 2), possible configurations for designing the cross section for the longitudinal members (2) are shown by way of example.

With particular preference, the longitudinal members (2) consist of a reduced-density steel alloy with a density of a maximum of 7.4 g/cm³, preferably containing the following alloying elements in % by weight: C: up to 0.4%, Al: 3.0-20.0%, P: up to 0.1%, S: up to 0.1%, N: up to 0.1%, and optionally one or more of the elements Nb: up to 0.5%, Ti: up to 0.5%, at least one assigned element from the group of rare earth metals: up to 0.2%, Mn: up to 20.0%, Si: up to 2.0%, Cr: up to 9.0%, Zr: up to 1.0%, V: up to 1.0%, W: up to 1.0%, Mo: up to 1.0%, Co: up to 1.0%, Ni: up to 2.0%, B: up to 0.1%, Cu: up to 3.0%, Ca: up to 0.1%, the remainder Fe and unavoidable impurities.

The transverse members (3) may consist of a multiphase steel alloy, for example a dual-phase steel, a complex-phase steel, a ferrite-bainite or a martensite-phase steel alloy with a tensile strength of at least 500 MPa, preferably at least 600 MPa, particularly preferably at least 700 MPa, the microstructure of the multiphase steel alloy consisting of at least two of the phases ferrite, bainite, austenite or martensite, or of a heat-treatable steel alloy, for example a hot-forming or air-hardening steel alloy with a tensile strength of at least 700 MPa, preferably at least 800 MPa, particularly preferably at least 900 MPa, the microstructure of the heat-treatable steel alloy consisting predominantly of martensite, in particular more than 90% of martensite. Alternatively, the transverse members (3) may also consist of a reduced-density steel alloy, preferably with an Al content of between 3.0 and 20.0% by weight. For example, the transverse members (3) may also consist of a conventional steel alloy known from the prior art.

The transverse members (3) and the longitudinal members (2) are in each case shaped by means of compression forming, tensile forming, tensile/compression forming, bending, shear forming or deep drawing, in particular by means of hot forming with optionally at least partial press hardening, or by means of a combination of the stated production processes.

By providing a reduced-density steel alloy for use preferably in longitudinal members (2), for example with, in % by weight: C=0.01-0.1%, Al=6.0-7.0%, P<0.01%, S<0.001%, N<0.02%, Nb=0.05-0.3%, Ti=0.05-0.4%, Mn<0.2%, Si=0.01-0.1%, Cr=0.2-0.8%, Ni<0.2%, B<0.0004%, the remainder Fe and unavoidable, smelting-related impurities, the mass can be reduced in the case of the vehicle frame (1) according to the invention in comparison with the vehicle frames known from the prior art, with a performance that is substantially comparable or remains the same; in particular, the total mass can be reduced by at least 10%.

The invention is not restricted to the exemplary embodiments represented in the drawing and to the configurations in the general description, but rather the longitudinal member (2) and/or the transverse member (3) may also be formed from a tailored product, for example from a tailored blank and/or a tailored rolled blank. Depending on the type of vehicle, the vehicle frame is designed with corresponding material thicknesses, which may also vary along the respective cross section, and be optimized in terms of loading and/or weight. The invention can also be transferred particularly advantageously to other types of vehicle, whether actively or passively powered.

1. A vehicle frame for receiving at least one vehicle component, comprising two substantially parallel longitudinal members, which extend at a distance from one another over their entire extent and are connected together by means of at least two transverse members joined by material bonding, non-positive engagement and/or positive engagement,
wherein at least one of the longitudinal members and/or at least one of the transverse members consists of a reduced-density steel alloy.

2. The vehicle frame as claimed in claim 1,
wherein the reduced-density steel alloy has a density of a maximum of 7.4 g/cm³.

3. The vehicle frame as claimed in claim 1,
wherein the reduced-density steel alloy contains the following alloying constituents in % by weight:
C: up to 0.4%,
Al: 3.0-20.0%,
P: up to 0.1%,
S: up to 0.1%,
N: up to 0.1%,

4. The vehicle frame as claimed in claim 3 wherein the transverse members are joined to the longitudinal members by material bonding, by means of welding or brazing, or by non-positive engagement, by means of a riveted or screwed connection.

5. The vehicle frame as claimed in claim 4 wherein at least one of the longitudinal members the transverse members are in each case shaped by means of compression forming, tensile forming, tensile/compression forming, bending, shear forming or deep drawing.

6. The vehicle frame of claim 4, wherein the vehicle frame comprises a vehicle frame in automobiles, commercial vehicles, trucks, special vehicles, buses, coaches, including one of an internal combustion engine electrical powertrain, and trailers.

7. The vehicle frame as claimed in claim 1, wherein the reduced-density steel alloy has a density of a maximum of 7.2 g/cm³.

8. The vehicle frame as claimed in claim 1, wherein the reduced-density steel alloy has a density of a maximum of 7.0 g/cm³.

9. The vehicle frame as claimed in claim 3 wherein the reduced-density steel alloy contains at least one of
Nb: up to 0.5%, and
Ti: up to 0.5%.

10. The vehicle frame as claimed in claim 9 wherein the reduced-density steel alloy contains at least one of
at least one assigned element from the group of rare earth metals: up to 0.2%,
Mn: up to 20.0%,
Si: up to 2.0%,
Cr: up to 9.0%,
Zr: up to 1.0%,
V: up to 1.0%,
W: up to 1.0%,
Mo: up to 1.0%,
Co: up to 1.0%,
Ni: up to 2.0%,
B: up to 0.1%,
Cu: up to 3.0%,
Ca: up to 0.1%,
the remainder Fe and unavoidable impurities.

11. The vehicle frame as claimed in claim 5 wherein the longitudinal members and the transverse members are in each case shaped by means of hot forming with at least partial press hardening, or by means of a combination of the stated production processes.
